(19) United States
(12) Patent Application Publication
(10) Pub. No.: US 2024/0308103 A1
(43) Pub. Date: Sep. 19, 2024

(54) CRAFT POTTERY CENTERING DEVICE

(71) Applicant: Darren Phillips, Haslemere (GB)

(72) Inventor: Darren Phillips, Haslemere (GB)

(21) Appl. No.: 18/674,817

(22) Filed: May 25, 2024

(51) Int. Cl. B28B 1/02

(52) U.S. Cl. CPC B28B 1/02

(57) ABSTRACT

Disclosed is a clay centering tool that comprises a curved body having a front part and a rear part. The front part is partitioned into smooth edge and ribbed edge to press a lump of clay. wherein the lump of clay is placed on a pottery wheel. Further a handle is attached to the rear part of the curved body.

### FIELD OF THE INVENTION

The present invention relates to craft pottery and more particularly relates to a device for centering clay on a pottery wheel.

### BACKGROUND OF THE INVENTION

Centering the clay on a pottery wheel is crucial when forming the shape of the clay also referred to as ‘throwing’ clay and is the initial step that ensures the uniformity of a clay article being created. As the potter shapes the article, properly centered clay allows for symmetrical thickness and stability. Otherwise, the shape of the clay article being made tends to be deformed, sometimes resulting in the clay forming a wobble making it difficult to produce the article according to the desired shape. To achieve proper centering, it requires a sufficient practice, strength, concentration and coordination. The potter uses both hands to apply even pressure while the pottery wheel spins, ensuring the clay stays balanced and symmetrical. However, centering clay on a pottery wheel by hand is quite challenging, especially for beginners and for potters who have arthritis or other painful ailments in their hands. Off-centered clay can cause structural weaknesses, leading to potential cracks or collapses during the shaping, drying, or firing stages. Therefore, the centering step is essential for producing pottery to the highest-quality.

As mentioned above, achieving proper centering is difficult since any slight misalignment or uneven pressure may cause the clay to wobble or become off-center, leading to an unevenly produced article.

On the other hand, there exists some mechanical centering devices to achieve the purpose as mentioned above. These devices may reduce the difficulty in centering the clay while also providing more control and stability, allowing for more precise adjustments. However, these mechanical devices are larger in size and have to be fixed to the potter's wheel. The edge that contacts with the clay is flat rather than being curved, a more inefficient approach. Such devices are heavy to use and cumbersome obstructing the throwing operation and are also very expensive.

Hence there is a need for a clay centering device that overcomes all the aforementioned drawbacks.

### BRIEF SUMMARY OF THE INVENTION

It is an object of the present invention to provide a centering device that aids in centering clay on a pottery wheel.

It is another object of the present invention to provide a centering device that is hand operated without the need to fix it to a structure.

It is another object of the present invention to provide a clay centering device that replicates the function of the palm and the pressure points of the hand.

It is a further object of the present invention to provide a centering tool for clay having a curved shape that replicates the function of the palm of the hand.

It is another object of the present invention to center clay on a pottery wheel using a centering device that is easy to handle for beginners and users with disabilities.

It is a further object of the present invention to provide a centering device for centering clay with a perfectly round profile on a pottery wheel in less time.

It is another object of the present invention to provide a clay centering tool that is less expensive.

According to an embodiment of the present invention, a clay centering tool is disclosed. The tool comprises a curved body having a front part and a rear part. The front part is partitioned into a smooth edge and a ribbed edge-each edge used alternately to press against the outside surface of the lump of clay, wherein the lump of clay is placed on a pottery wheel. Further, a handle is attached to the rear part of the curved body.

According to another embodiment of the present invention, a clay centering tool is disclosed. The tool comprises a curved body having a front part and a rear part, wherein the front part is configured with smooth surface. Further, a handle is attached to the rear part of the curved body.

According to another embodiment of the present invention a method of centering clay is disclosed. The method is implemented using a clay centering tool, the tool having a curved body and a handle attached therewith. The method includes placing a lump of clay on a pottery wheel. The method also includes turning of the pottery wheel to rotate slowly. The method further includes gradually speeding up the pottery wheel. The method includes wetting the clay centering tool and the lump of clay. The method also includes slowly placing a first edge of the clay centering tool at a slight sideways angle over the clay. The method further includes pressing the clay centering tool slowly and firmly into the clay towards the center of a wheel head. The method includes releasing the tool from clay once an outside edge of the clay is formed with the shape of the first edge and the clay is centered. The method also includes slowly placing a second edge of the clay centering tool at a slight sideways angle over the clay to form a smooth surface of the clay. The method further includes releasing the tool from the clay.

### BRIEF DESCRIPTION OF DRAWINGS

The present invention will become clearly understood to those of ordinary skill in the art when descriptions of exemplary embodiments thereof are read with reference to the accompanying drawings.

FIG. 1A is a perspective view of a clay centering tool according to an embodiment of the present invention.

FIG. 1B is another perspective view of the clay centering tool of FIG. 1. FIG. 1C is another perspective view of the clay centering tool of FIG. 1.

FIG. 2A depicts the clay centering tool of FIG. 1 while in operating condition.

FIG. 2B depicts the clay centering tool of FIG. 1 while in operating condition.

FIG. 3 is a perspective view of a clay centering tool according to another embodiment of the present invention.

FIG. 4 depicts a clay centering tool of FIG. 3 while in operating condition.

### DETAILED DESCRIPTION OF THE INVENTION

The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention. For a more complete understanding of the present invention, reference is now made to the following descriptions taken in conjunction with the accompanying drawings.

The present invention discloses a curved-shaped clay centering tool to form a perfectly round profile on the clay placed on a pottery wheel head. Advantageously, the clay centering tool has an elongated handle to grip easily while shaping and centering the clay. The tool is also configured with different edges to shape the clay to a precise dome profile. Further, the tool replicates the function of both the palm of the hand and the pressure points of the hand such that a natural dome shape of clay is achieved. The tool is constructed using materials including, but not limited to, 3D printed Polylactic Acid (PLA+) and other plastic polymers, including fiber reinforced polymers.

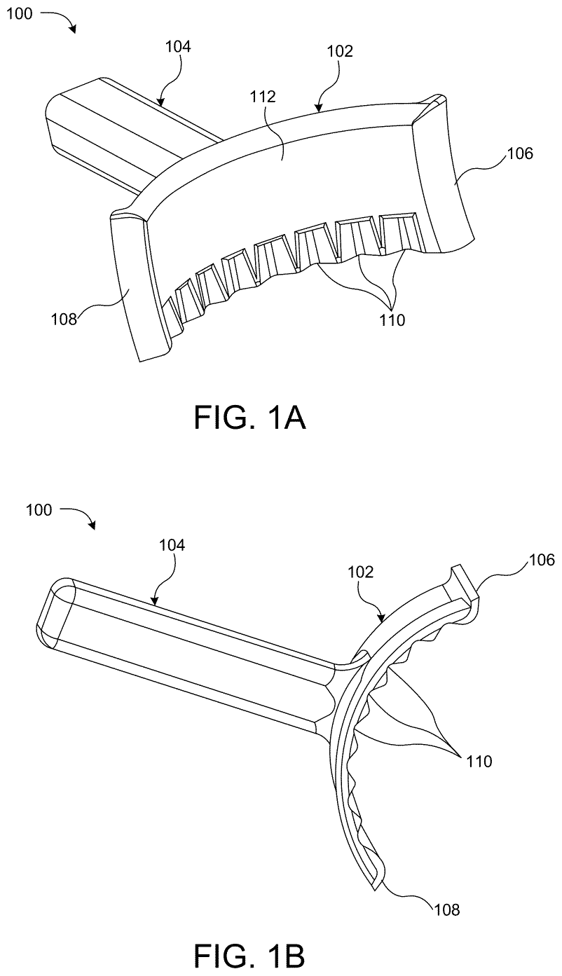

According to an exemplary embodiment of the present invention, a clay centering tool 100 is disclosed as shown in FIGS. 1A, 1B and 1C. The tool 100 is configured to press and center the clay which is placed on a wheel head of a pottery wheel. Further, the tool 100 accurately forms a dome shaped profile with its distinct structure. In one aspect, the tool 100 includes a curved body 102 having a front part and a rear part. In the exemplary embodiment, the front part is partitioned into a smooth edge 112 and a ribbed edge 110. The smooth edge 112 and ribbed edge 110 are configured to press a lump of clay which is placed on the pottery wheel head. In the same aspect, the tool 100 further includes a handle 104. The handle 104 is an elongated handle 104 which helps a potter to conveniently hold with sufficient grip while pressing the clay. The handle 104 is attached to the rear part of the curved body 102.

In one aspect, the clay centering tool 100 further includes a slightly curved top part 106 and slightly curved bottom part 108 each having a smooth surface. In one aspect, the ribbed edge 110 is configured to press the lump of clay at the first stage of the clay centering process while the smooth edge 112 is configured to press the lump of clay at the second stage of clay centering process.

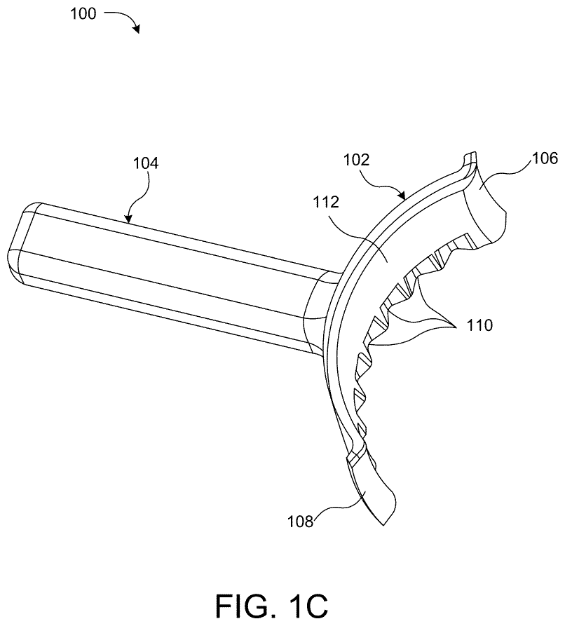

Referring FIGS. 2A and 2B, the first stage 200 and second stage 250 of clay centering processes are depicted, respectively. A lump of clay 204, 208 is seen to be placed over a wheel head of a pottery wheel 202. In FIG. 2A, a potter holds a handle 206 of the tool 100 and slightly presses the clay in sideways using the ribbed edge (not shown) of the front part of the curved body of the tool 100 while placing the slightly curved bottom part of the tool 100 to touch the wheel head. This forms the first stage 200 of the centering process where the ribbed edge presses the clay to center the clay and forms a dome structure. The ribbed edge replicates the function of the fingers and metacarpel knuckle bones i.e. the pressure points of the hand such that the clay forms a bechive type structure while being pressed using the ribbed edge. With the ribbing structure, the clay is centered more quickly and consistently.

In FIG. 2B, the potter holds the handle 206 of the tool 100 and slightly presses the clay in sideways using the smooth edge of the front part of the curved body of the tool 100 while placing the slightly curved top part of the tool 100 to touch the wheel head. This forms the second stage 250 of the centering process where the smooth edge presses the clay to center the clay and forms a smooth dome structure.

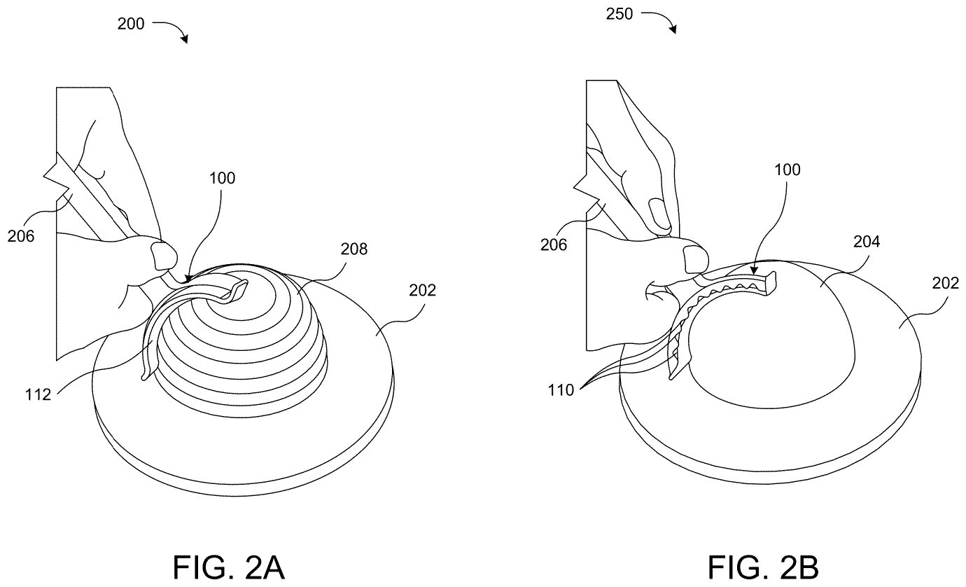

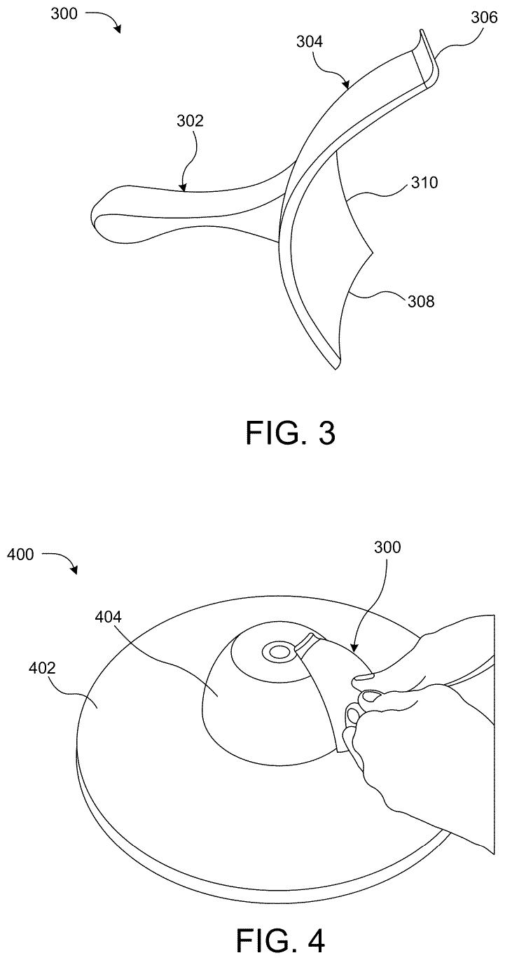

According to an exemplary embodiment of the present invention, a clay centering tool 300 is disclosed as shown in FIGS. 3 and 4. Referring FIG. 3, the tool 300 comprises a curved body 304 having a front part and a rear part. The front part is configured with a smooth surface 310. In one aspect, the tool 300 further includes a handle 302 attached to the rear part of the curved body. Further, the clay centering tool 300 includes a slightly curved top part 306 and a slightly curved bottom part 308 each having a smooth surface. In an aspect, the smooth edge is configured to press the lump of clay in slightly sideways to center the clay and to form a dome shaped profile on a pottery wheel.

In FIG. 4, a clay centering process 400 is depicted using the tool 300. The clay 404 is placed on a wheel head of a pottery wheel 402. A potter holds the tool 300 using the handle (not shown) at the rear part and presses the front part of the curved body of the tool 300 in slightly sideways, such that the clay is centered while forming a dome shaped profile on the pottery wheel.

According to another embodiment, a method of centering clay using a clay centering tool is disclosed. The tool includes one of the tools 100, 300 as disclosed in the FIGS. 1A and 3. The tool includes a curved body 102, 304 and a handle 104, 302 attached therewith. The method includes placing a lump of clay on a pottery wheel and turning on the pottery wheel to rotate slowly. The pottery wheel is then gradually sped up. The clay centering tool and the lump of clay are wetted and are slowly placing a first edge of the clay centering tool at a slight sideways angle over the clay. During this stage, a bottom part of the tool is placed in contact with a wheel head of the pottery wheel while placing the first edge of the clay centering tool over the clay in sideways.

The clay centering tool is slowly and firmly pressed into the clay towards the center of a wheel head. The tool is released from clay once an outside edge of the clay is formed with the shape of the first edge and the clay is centered. Then a second edge of the clay centering tool is slowly placed at a slight sideways angle over the clay to form a smooth surface of the clay. During this stage, a top part of the tool is placed in contact with the wheel head of the pottery wheel. The tool is released from the clay upon formation of a dome-shape and the clay is centered. In an exemplary aspect, the first edge is the ribbed edge and the second edge is the smooth edge.

It is understood that the smooth edge and the ribbed edge of the tool replicate the functions of both the palm of the hand and the pressure points of the hand i.e. metacarpel knuckle bones, respectively such that natural dome shape of clay is achieved while also accurately centering the clay. With the help of the ribbing structure, the clay is centered more consistently and quickly on the basis that it is easier to center smaller sections of clay at any given time therefore acting to center several individual sections of clay collectively in the same time frame. Since the tool is hand operated, no additional components are required to fix the tool to a structure, such that the tool is affordable. The centering operation is performed and achieved in less time. With the simple design of the clay centering tool disclosed herein, pottery making is more accessible for people with disabilities and a novice potter learns the principle involved in centering clay.

It will finally be understood that the disclosed embodiments are presently preferred examples of how to make and use the claimed invention, and are intended to be explanatory rather than limiting the scope of the invention as defined by the claims below. Reasonable variations and modifications of the illustrated examples in the foregoing written specification and drawings are possible without departing from the scope of the invention as defined in the claim below. It should further be understood that to the extent the term “invention” is used in the written specification, it is not to be construed as a limited term as to number of claimed or disclosed inventions or the scope of any such invention, but as a term which has long been conveniently and widely used to describe new and useful improvements in technology. The scope of the invention supported by the above disclosure should accordingly be construed within the scope of what it teaches and suggests to those skilled in the art, and within the scope of any claims that the above disclosure supports. The scope of the invention is accordingly defined by the following claims.

This application is intended to cover any adaptations or variations of the present invention. Therefore, it is manifestly intended that this invention be limited only by the claims and the equivalents thereof.

1. A clay centering tool comprising:
a curved body having a front part and a rear part,
wherein the front part is partitioned into a smooth edge and a ribbed edge to press
a lump of clay, wherein the lump of clay is placed on a pottery wheel; and
a handle attached to the rear part of the curved body.

2. The clay centering tool according to claim 1 further includes a slightly curved top part and slightly curved bottom part each having smooth surfaces.

3. The clay centering tool according to claim 1, wherein the ribbed edge is configured to press the lump of clay at the first stage of the clay centering process.

4. The clay centering tool according to claim 1, wherein the smooth edge is configured to press the lump of clay at the second stage of the clay centering process.

5. The clay centering tool according to claim 1 is constructed using 3D printed Polylactic Acid (PLA+) and other plastic polymers, including fiber reinforced polymers.

6. A clay centering tool comprising:
a curved body having a front part and a rear part,
wherein the front part is configured with a smooth surface; and
a handle attached to the rear part of the curved body.

7. The clay centering tool according to claim 6 further slightly curved top part and slightly curved bottom part each having smooth surface.

8. The clay centering tool according to claim 6, wherein the smooth edge is configured to press the lump of clay to center the clay and to form a dome shaped profile on a potter wheel.

9. The clay centering tool according to claim 6 is constructed using 3D printed Polylactic Acid (PLA+) and other plastic polymers, including fiber reinforced polymers.

10. A method of centering clay using a clay centering tool, the tool having a curved body and a handle attached therewith, the method comprising:
placing a lump of clay on a pottery wheel;
turning on the pottery wheel to rotate slowly;
gradually speeding up the pottery wheel;
wetting the clay centering tool and the lump of clay;
slowly placing a first edge of the clay centering tool at a slight sideways angle over the clay;
pressing the clay centering tool slowly and firmly into the clay towards the center of a wheel head;
releasing the tool from the clay once an outside edge of the clay is formed with the shape of the first edge and the clay is centered;
slowly place a second edge of the clay centering tool at a slight sideways angle over the clay to form a smooth surface of the clay; and
releasing the tool from the clay.

11. The method according to claim 10 further comprising placing a bottom part of the tool in contact with a wheel head of the pottery wheel while placing the first edge of the clay centering tool over the clay.

12. The method according to claim 10 further comprising placing a top part of the tool in contact with the wheel head of the pottery wheel while placing the second edge of the clay centering tool over the clay.

13. The method according to claim 10, wherein the first edge is the ribbed edge.

14. The method according to claim 10, wherein the second edge is the smooth edge.

15. The method according to claim 10, wherein the clay centering tool is constructed using 3D printed Polylactic Acid (PLA+) and other plastic polymers, including fiber reinforced polymers.
